(19) United States
(12) Patent Application Publication
(10) Pub. No.: US 2022/0050424 A1
(43) Pub. Date: Feb. 17, 2022

(54) TIMING DEVICE WITH AUDIBLE INDICATION

(71) Applicant: Big Potato Limited, Leicester (GB)

(72) Inventor: Francis DUFORT, Wadebridge (GB)

(21) Appl. No.: 17/426,181

(22) PCT Filed: Jan. 29, 2020
(86) PCT No.: PCT/EP2020/052140

§ 371 Date: Jul. 28, 2021

(30) Foreign Application Priority Data
Jan. 29, 2019 (GB) 1901212.9

(51) Int. Cl. G04F 1/06

(52) U.S. Cl. CPC G04F 1/063

(57) ABSTRACT

The invention provides a device (100) for timing that audibly provides an indication of elapsing time. The device being similar to an hourglass, having two containers connected by a central passage and filled with particulates. Wherein one of the containing halves of the device has a recessed portion and sounding surface positioned under the connecting passage, and is arranged to produce sound when its internal surface is struck by a falling particulate.

The present invention relates to a timing device that audibly provides an indication of elapsing time.

There are many applications where it is desired count down a period of time to time an event. Various mechanical and electronic devices are known to perform this function with various levels of complexity and cost that make them suitable for different applications.

Hourglasses and egg timers are examples of devices used to measure the passing of an allocated period of time. An hourglass visually indicates this passing of time by providing a user with a steady rate of particulate flow from an upper chamber into a lower chamber under the action of gravity. A neck portion connecting the chambers regulates the rate of flow such that it takes a predictable period of time for all the particulates to fall from the top half to into the bottom half of the hourglass.

In today's world, timers like these are most commonly used to time periods for taking turns in board games, cooking food and other simple applications where high precision is not required and cost and simplicity are of importance. Such devices have the advantage of being simple and relatively inexpensive to manufacture. However, they have the disadvantage that it is necessary visually monitor on how much sand is left in the upper portion of the hourglass to ensure the correct period of time is adhered to. In some situations it is not convenient to continually visually monitor the progress of the falling sand as the user's attention is demanded elsewhere, for example when cooking, or when taking a turn in a board/card game.

Other timing devices may have an auditory indication of time elapsing as well as or as an alternative to a visual indication which means the user does not have to keep a visual check on the timing device. For example, electronic or clockwork devices may comprise a buzzer arranged to sound when time has elapsed. These however require more complicated mechanisms that may be expensive to manufacture, be prone to breaking, or require replacement batteries periodically.

The patent U.S. Pat. No. 372,090 discloses an hourglass type device that provides an audible noise as a shot falls from the upper portion of the hourglass into the lower portion and collides with a plate raised on a rod or stem. The rod or stem connects the plate through the bottom of the portion to a diaphragm underneath device which is caused to vibrate as shot hits the plate to produce sounds.

The invention is set out in the claims.

According to a first aspect of the present invention there is provided a timing device that audibly provides an indication of elapsing time, the device comprising;
a container having walls defining first and second compartments connected by a passage;
particulates contained in the container;
wherein, with the device positioned to have the compartment containing the particulates uppermost, particulates fall into the lowermost compartment through the passage which regulates their rate of fall such that the particulates accumulate in a base of the lowermost compartment in a set time,
wherein a portion of the wall defining at least one compartment is recessed and has a sounding surface positioned under the passage that is arranged to produce sound when its internal surface is struck by falling particulate providing an externally audible indication of elapsing time,
wherein the recessed portion of wall positions the sounding surface higher than the base of the compartment forming a well in which falling particulate accumulates after striking and rebounding from the sounding surface.

Thus, the falling particulate produces a sound as it strikes the sounding surface giving audio feedback that the timer is still running and the set time has not elapsed. Once the particulate has emptied out of the upper compartment, the sound stops alerting users of the device that the time period is expired without the user having to continually watch the timer visually. By creating a well under the level of the sounding surface, the particles rebounding from the surface accumulate fall under gravity into the well, rather than piling up on top of the sounding surface. Thus, this avoids particles piling up on top of the sounding surface and damping the sounding surface from vibrating and producing sound. The portion of wall providing the sounding surface is preferably an external wall of the device with a free path or channel from it to the surrounding atmosphere so the sound can reach the users without significant attenuation. By using a recessed wall of the container to elevate a sounding surface above a well portion in the base of the container, the device can be made simple and low cost to manufacture. The recess also helps protect the sounding surface, which is typically thinner than the surrounding walls of the recess and other external walls of the device, and which so may be delicate, by placing it in a position where it is more difficult to accidentally impact and potentially damage.

The sounding surface can be a contiguous, preferably smoothly continuous, part of the recessed portion of wall, which lends itself to simple manufacture.

Generally, the device provides a new way of producing an hourglass type timer with audible feedback to indicate the passing of time. As particulates collide with a surface, sound waves are created in a recessed portion and propagate out to the surrounding air. The specific design details disclosed amplify the sound waves and/or direct them such that they may be heard more clearly. There are also features that provide a visual indication of when certain fractions of the overall predetermined time period has elapsed, the particulates uniformly filling a well and covering up the relevant time period markers.

The timing device may be used in a toy or game and may be suited to applications where very accurate timing is not need and where auditory feedback of elapsing time is desired. The device may be configured to measure any suitable time period, as per conventional “hour glasses”, e.g. tens or seconds, minutes, tens or minutes, etc., by varying volume of particulate and rate at which the channel regulates flow between the compartments.

The device produces sound either hand held or with its base placed on a surface, i.e. a table top of the like. It will be appreciated that references to the base of the device or compartment are in relation to the device being orientated with a particular compartment lowermost such that the base forms the lowest part of the compartment such that particulate falls into that compartment and accumulates in the base of that compartment. Thus, the device in effect has two possible bases depending on its orientation and the terms should be construed consistently with this use.

In embodiments, both compartments have a sounding surface such that particulate flowing in either direction produces a sound.

The sounding surface is preferably a thin elastic member capable of vibrating when struck by particulate. Thus, the sounding surface may be a flexible membrane under tension or rigid plate member.

The sounding surface may be flat or at least centrally flat. In an embodiment, the sounding surface is at least partially concave. Thus, for examples, the surrounding edges can slope downwards to help dislodge particulate so it falls into the well.

Particulate generally means anything that can flow from one compartment to another in discrete quantities under gravity in a regulated fashion and cause a vibration to be induced in a membrane or plate member to produce a sound when it strikes that surface. This might be sand or other like material.

In an embodiment the recessed wall portion externally forms a channel and/or an acoustic horn surrounding the external face of the sounding surface, which amplifies and/or guides sounds produced by the sounding surface. Thus, the recess may serve the double purpose of creating the well as described above and also for helping condition the sound produced by the sounding surface to be suitable the auditory reception by the human users/listeners of the device. For instance, the shape of the recessed portion help tune harmonics of the sound to concentrate sound in a particular frequency range and/or to spread out the sound circumferentially around the device so that the sound can be heard equally in all circumferential positions of the listener relative to the device or orientation of the device.

The internal walls of the compartments are preferably generally continuous and smooth with no projecting or overhanging features that might undesirably trap particulates when the device is inverted. The base portion of the compartment may be toroidal around a smooth walled recessed portion. In embodiments, the recessed portion and/or well may be substantially rotationally symmetric to provide even sound, e.g. around an axis extending through the passage and sounding surface normal to the base of the device.

Thus, the recessed wall may be outwardly flared, e.g. frustoconical or horn shaped or otherwise shaped to help modulate the sound to make it more audible to external listeners.

In an embodiment, the recess is in the base of the device with the well extending circumferentially around the recessed portion.

Circumferentially used herein is in relation to an axis between the compartments through the passage, which is normally normal to the bases of the device, i.e. the forming the vertical axis when the device is set upon a surface or held in operation along which axis the particulate generally falls in operation to strike the sound surface.

In an embodiment, a plurality of external feet are disposed on the base of the device circumferentially spaced around the recessed portion, such that, with the device placed on a surface, channels are formed between the feet and surface allowing sound to travel from the recessed portion. The channels may be shaped to amplify or direct the sound, e.g. to provide an even sound level at all circumferential positions around the device. The feed may be blade like so as to maximise the width of the channels and minimise the barrier presented to sound propagating out of the device.

In an embodiment the plurality of channels between the feet are shaped to amplify the sound created by a particulate colliding with the sounding surface.

In an embodiment the shape of the plurality of channels resembling a part of a horn for increasing the amount of air the sound waves acts upon. Thus, the channels may flare outwards to continue the flare of the recess and provide a sound channel suitable for propagating the sound into the atmosphere in a way that enhances the sound for listeners.

In an embodiment the sounding surface is less thick than the rest of the recessed walls of the container.

In an embodiment, the thickness of the sounding surface is proportional to the size and mass of the particulates designed/chosen to collide with it. Thus, bigger heavier particles may require a thicker sounding surface.

In an embodiment, the sounding surface is formed of a different material than the recessed portion it is affixed to.

In an embodiment, the sounding surface is made of flexible elastic sheet material fixed under tension to a rigid frame provided by the rest of the recessed wall portion which vibrates when a particulate collides with it to produce a sound.

In an embodiment, the sounding surface is unitary with the rest of the recessed wall portion.

In an embodiment, the sounding surface is between 0.05 and 0.75 millimetres thick. In an embodiment, the sounding surface is between 0.5 cm2 and 10 cm2 in area. It will be appreciated that the size and thickness selected will depend on various factors such as the overall size of the device, the particulate size and mass and rate of flow, the desired sound, etc.

It will be appreciated that the overall device can be made small or large according to the application, and that generally the size and thickness of the sounding surface and the size of the particles can be scaled or sized according to the sound desired to be produced. These exemplary ranges have been found to produce generally good results in common applications. Nonetheless, other sizes and combinations may be used and selected by performing routine experimentation to find desired combinations.

In an embodiment, a portion or portions of the walls of the device are transparent providing a visual indication of the extent to which the particulate has accumulated in the lower compartment and so of elapsing time.

In an embodiment, there are identification markers on the interior walls of recessed portion that indicate how much time has passed as particulates build up and cover the identification markers.

In some embodiments, it is possible that the particulate building up in the well against the interior walls of the recessed portion acts to damp the sound generated by the sounding surface, e.g. affect its volume or pitch as particulate builds up, to give further audible feedback as to the passage of time. In embodiments, the interior walls of the recessed portion may be stepped corresponding to sub divisions of the overall time period to give discrete transitions in the sound generated during those sub periods.

In an embodiment, the device is constructed from at least one unitary moulded plastics part providing the recessed portion of wall and sounding surface for a respective one or both base ends of the device, wherein the sounding surface has a thinner wall thickness than the surrounding recessed wall portion. This makes the end caps simple to manufacture. In other embodiments, unitary part may be formed by stamping a metal sheet to form the end caps.

In an embodiment, the unitary part further provides at least part of the base of a compartment forming at least part of the well.

In an embodiment, the or both unitary part is joined to at least one other part defining the circumferentially outer walls of the compartments and the passage therebetween. This can be made from transparent plastics to allow the progress of the falling particulate to be visually monitored.

In an embodiment, the compartment is unitary and preferably made from glass. The particulate is included within the compartment as the compartment is formed. The sounding surface may be formed by making a locally thinner walled portion of glass.

In an embodiment, comprising end caps fixed to one or both ends of the compartment providing a protective shield over the opening of the recessed portion having one or more apertures therein to protect the sounding surface whilst allowing sound out of the recessed portion. Thus, where the compartment is made of glass, the end cover generally provides a protective cover for the end, and in particular, the protective shield part protects the delicate sounding surface from impacts from external objects. The end cap may also provide feet, as described above, lifting the compartment off a surface on which it stands to provide channels for sounds to escape the recessed portion and otherwise be shaped to channel or amplify the sound.

In an embodiment, there are sounding surfaces in different compartments arranged to produce different sounds.

In an embodiment, the device comprises plural containers comprising interconnected compartments each with a sounding surface, wherein the containers are axially orthogonal such that depending on the orientation of the device, particulate is made to fall in one of the containers, wherein each container has a sounding surface that produces a different sound to another container and/or has a different set time.

Thus, for example three containers can be provided in a cube form, with opposed faces of the cube corresponding to the respective bases of two compartments of a particular container, each container having a different time period and/or sound. Thus, different time periods can be made available each with a different indicative sound. The device could be rotationally mounted or rolled like a die to introduce a random element into which time period is selected. The particulates that travel between compartments in each of the containers may be of a different colour or size than the particulates to the others.

In another embodiment, the container has three or more compartments each connected to another one of the compartments via a passage and each having its own sounding surface, wherein respective pairs of compartments have different axial orientations such that the same particulate can be made to fall between different pairs of compartments depending on the orientation of the device. The sounding surfaces may be arranged to produce different sounds and/or the different pairs of compartments may time different time periods.

Other aspects extend to a method of manufacturing a timing device as described above.

In an aspect, the invention extends to a timer of the type where matter, e.g. liquid or solid particulate matter, falls between two compartments in a set time, wherein at least one compartment has a sound producing element inwardly offset from the base of the compartment which is set to vibrate and produce sound as the falling matter strikes the element to provide an audible indication of elapsing time.

### BRIEF DESCRIPTION OF THE DRAWINGS

Embodiments of the present invention will now be described in detail with reference to the accompanying drawings, in which:

FIG. 1 is a perspective view of an example of a timing device according to an embodiment of the invention;

FIG. 2 is a side-on plan view of the device of FIG. 1;

FIG. 3 is a side-on view of another example of a timing device, showing particulate matter accumulated in the lower compartment in partial cut away to show visual time period markers; and

FIG. 4 is a side-on plan view of another example of a timing device, where the particulate matter is contained within a glass container with plastic end caps comprising feet attached.

### DETAILED DESCRIPTION

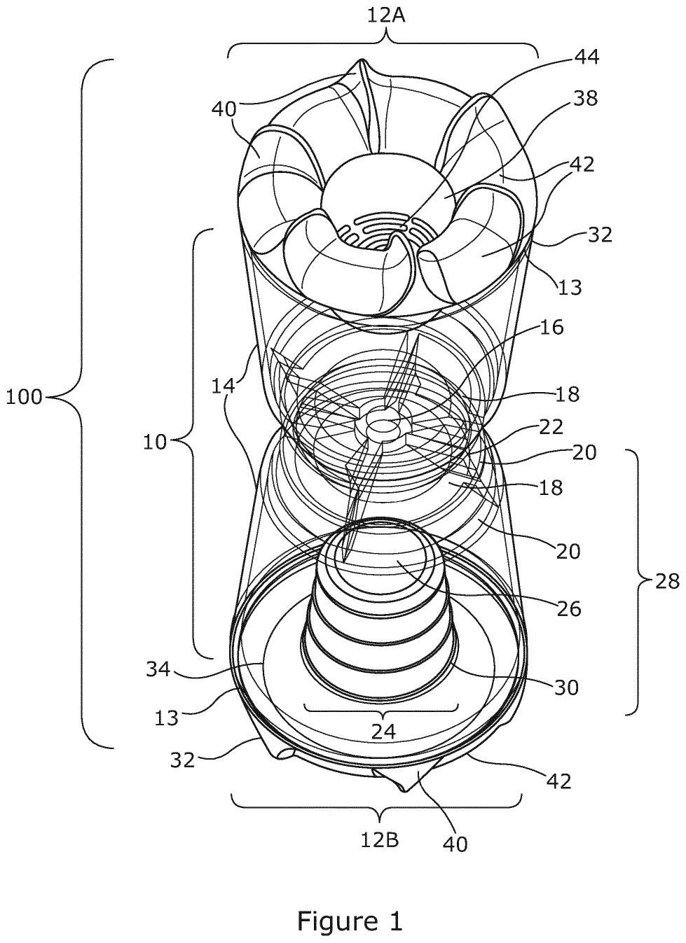

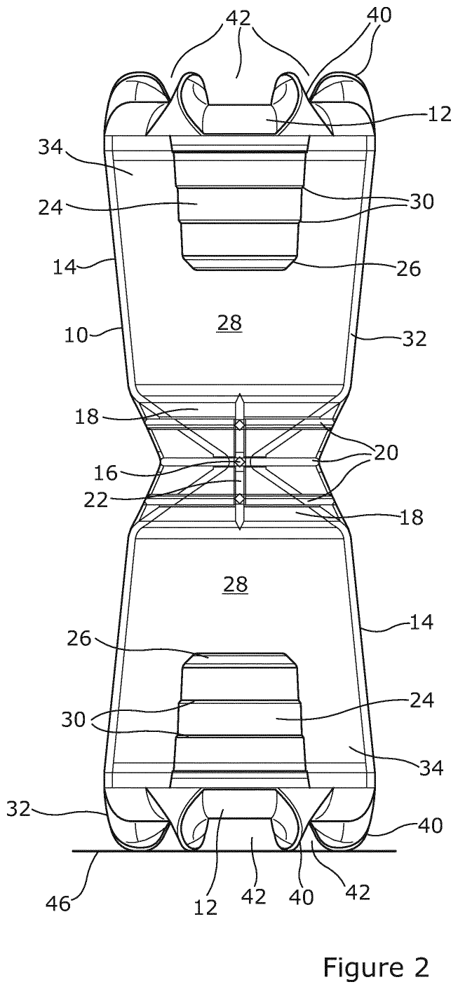

FIGS. 1 and 2 show a timing device 100. The timing device 100 comprises of a hollow central tubular piece 10 and symmetrical and diametrically opposed end caps 12, sometimes referred to as end cap 12A and end cap 12B, fitting over the ends of the tubular piece 10.

The sides 14 of the central tubular piece are cylindrical and extend axially away from the end caps 12 towards a central channel 16. As the sides 14 extend towards the central channel 16 they taper in becoming funnels 18 which meet at the central channel 16. In this embodiment there are a number of concentric rings 20 and struts 22 which provide support to the narrower section of the central tubular piece 10, where the funnels 18 meet and the central channel 16 resides.

Central tubular piece 10 is formed of a transparent material such as, but not limited to, plastic (e.g. Clear ABS), Acrylic or other resin, glass. It will be appreciated that when a visual indication of the elapsing time is not required, the material need not be transparent.

The end caps 12 are generally circular to fit the ends of the tubular piece 10 and may be attached to the hollow central piece 10 in a number of ways including, but not limited to, being glued, friction fit, screwed or any combination thereof, to the central tubular piece 10. The end caps 12 have a central portion where the walls forming the end cap are recessed inwards providing a recessed portion 24 with a sounding surface 26 at the end thereof, either formed with or attached to it. The sounding surface 26 is generally thinner than the surrounding wall portions such that it can be set to vibrate supported by the surrounding wall portions. When the end caps 12 are attached onto the central tubular piece 10, the recessed portions 24 and sounding surfaces extend within the central tubular piece 10, they reside diametrically opposite to the central channel 16 and face the opposing end cap 12. In this configuration the recessed portions 24 extend into the particulate chambers 28 of the central tubular piece 10. As the recessed portion 24 extends into the particulate chamber 28 it tapers inwards until forming a flattened portion where the sounding surface 26 resides. The tapered surfaces may be tapered in steps 30 or otherwise have transitions marking different time periods.

The central piece 10 and end caps 12 form a closed container with two compartments formed at either end connected by the central channel 16, in which particulate matter is contained, e.g. sand or the like. Thus, in the normal manner of an hourglass, inverting the device such that the particulates are in the uppermost compartment results in the particulates falling from the upper compartment to the lower compartment through the central channel, which is sized or otherwise adapted to regulate the rate of flow so that it takes a predictable time period for the particulate matter to fully transfer from the upper compartment to the base of the other lower compartment.

As particulates fall into the lower compartment, they collide with the sounding surface 26 which is caused to vibrate and produce a noise providing audible feedback of elapsing time. The end caps 12 and the sides 14 together form generally toroidal wells 34 around the recessed portions 24. These toroidal wells 34 provide space for particulates 36 to fall into after colliding with and rebounding from the sounding surface 26. This prevents particulates from building up on top of the sounding surface and dampening further vibration.

Viewed from the outside of the device 100, the recessed portions 24 of the end caps 12 resemble cavities 38 on the outer surface 32 of the timing device 100. These cavities 38 are hollow and allow for sound waves created by vibration of the sounding surface to externally propagate away from the device so as to be audible to listeners. In other words, the outside of the sounding surface forms an external wall of the device such that vibration caused by particulates falling on the internal side of the sounding surface give rise to sound waves that can freely propagate away from the device through the surrounding air. The cavities 38 are preferably shaped to help modulate the sound, i.e. having a flared or outwardly tapered provide to amplify or channel the sound in desired directions.

The end caps also have a plurality of feet 40 and, in between, a corresponding plurality of sound channels 42. The feet 40 are blade-like in a radial direction and situated on the bases of the end caps 12 circumferentially around the recess around the longitudinal axis that extends from one end cap 12A, through the central channel 16 to the other end cap 12B. The feet 40 are positioned such that when one end cap 12, of the timing device 100, is placed feet first onto a surface 46 (shown in FIG. 2) the sound channels 42 provide clear pathways for air and sound to travel into or out of the cavity 38. The sound channels 42 are preferably formed to resemble a horn when the device is placed on a surface. The opening of a sound channel 42 in combination with the sides of the feet 40 and the surface the device is placed upon resembling the opening of a horn. The end caps 12 are designed such that when the device is placed on a surface any sound produced in the cavity 38, when a particulate 36 collides with the sounding surface 26, propagates as a wave through the air out of the sound channels 42. The sound channels 42 causing any sound produced in the cavity 38 to emanate radially outwards from the timing device 100.

The device does not have its base placed on a surface to work however. It can be hand held or supported in a cradle in which it can rotate.

In the present example, the sounding surface 26 is formed of the same material as the rest of the end caps 12. Furthermore, the sounding surface 26 is formed integrally with the rest of the end caps 12. This may lend itself to using simple and inexpensive manufacturing techniques. In the present example, the end cap 12 is injection moulded and formed out of one piece of a material such as, but not limited to, plastics. The sounding surface 26 is formed more thinly than the surrounding material of the end cap 12 so that when a particulate 36 collides with it, it is able to vibrate and produce sound waves in cavity 38. Typically, if formed of injection moulded plastic, the sounding surface may be, for example, between 0.1 and 0.75 mm in thickness. It will be appreciated that the actual thickness used will depend on the particular application other factors such as the size and mass of the particulate matter, the size of the sounding surface, etc.

In other examples the sounding surface 26 may be formed of a separate thin material that is attached to the end cap 12, e.g. rubber, latex, silicone, thin metals, various plastics including PET & HIPS. If formed of a separate material from the rest of the end caps 12, it may be made of a flexible material stretched over the rigid walls of the recessed portion 24 like the skin of a drum. The thickness of the stretched material might typically be between 0.05 mm and 0.75 mm.

The external surface of the sounding surface 26, i.e. the inner most surface of cavity 38, has a plurality of annular ribs 44 formed into it. These ribs 44 are formed into the surface to reinforce the surface, e.g. to prevent shear or tearing, and may also be used to shape the sound produced in the cavity 38.

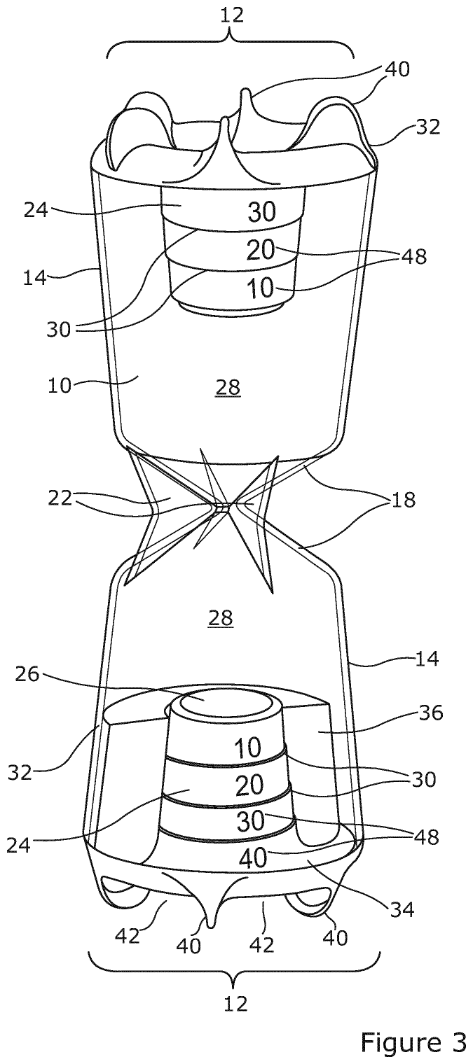

FIG. 3 shows a perspective view of another example of a timing device 100. This is generally similar to the device shown in FIGS. 1 and 2, except for a different arrangement of supports 22 around the central channel, and like reference numerals are used for like parts. FIG. 3 displays the particulates 36 as residing within the toroidal well 34 in the lower particulate chamber 28. The particulates 36 accumulation has been partially cutaway so that time markers 48 are visible through the transparent central tubular piece 10. These time markers 48 provide an indication of how much time has passed since the particulates were all in the upper particulate chamber 28. The steps 30 in the surface of the recessed portion indicate divisions between the time period indicated by the markers 48. As particulates fall from the upper particulate chamber 28 into the lower particulate chamber 28 they collide with the sounding surface 26 and rebound into the toroidal well 34. As the particulates 36 build-up in the toroidal well 34 they slowly, but in a consistent manner, cover up the time markers one by one, such that the level of the particulates provides the user with a regular indication that a portion of the total time measured by the device has passed.

Thus, as described above, a preferred timing device 100 with auditory feedback may be simply and inexpensively manufactured using identical moulded plastics end caps, with thinner walls of the moulded end caps providing the flexible sounding surface, which are attached to the ends of a transparent plastic, e.g. Perspex, sleeve after introducing particulate matter into the interior of the compartment, thus being formed by three main parts.

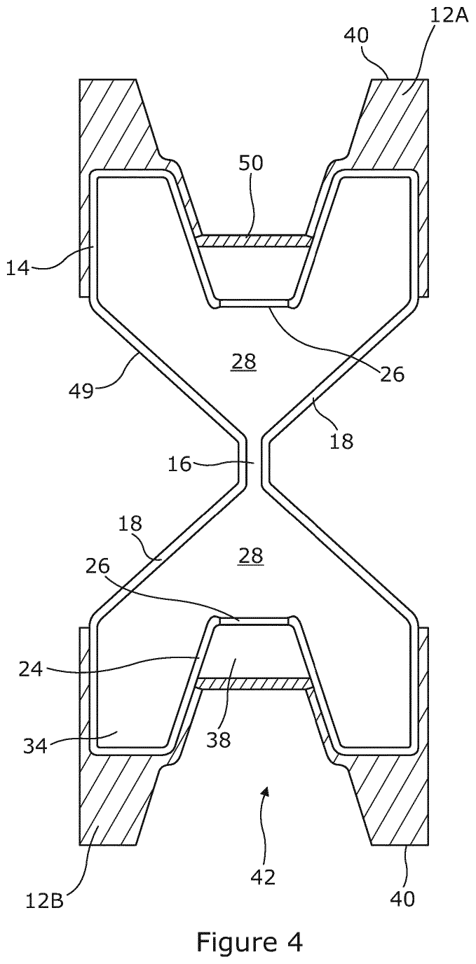

The device can be used to measure and record a period of time as follows. At rest the particulates 36 contained within the timing device 100, and its alternate embodiments in FIG. 3 (and FIG. 4 described below), can be spread across both particulate chambers 28. It is initially necessary to position the device such that all particulates 36 reside within only one of the particulate chambers 28, i.e. by turning the device so that one particulate chamber 28 is positioned above the other chamber so that the particulates 36 gradually fall through the central channel 16 into the lower particulate chamber 28.

Then, when it is desired to begin timing, the device is turned upside down and placed on a flat surface. Now the particulate chamber 28 containing all the particulates 36 is above the empty particulate chamber 28. The particulates 36 are now able to fall from the above particulate chamber 28 through the central channel 16 and into the other particulate chamber 28. In the process of falling, the central channel 16 directs the particulates 36 into colliding with the sounding surface 28. As the particulates 36 collide with the sounding surface 28 they cause it to vibrate which in turn produces sound waves in the cavity 38 that are able to propagate out, through the air, and to the user via the sound channels 42.

As the particulates 36 empty out of the above particulate chamber 28 a continual noise indicating the timer is still running can be heard. After colliding with the sounding surface 28 particulates 36 are scattered and fall into the toroidal well 34. In the alternate embodiment of FIG. 3, the particulates 36 that build up in the toroidal well 34 and over time cover up the time markers 48, indicating a known portion of the overall time of the timer has elapsed.

Finally as the last particulate 36 falls into the lower particulate chamber 28 the noise produced by any collisions stops. This indicates a full period of time the timing device 100 can measure has elapsed. It is possible to instantly restart the timer at this point in order to record any multiple of the period of time the timer has been designed to record.

FIG. 4 shows a perspective view of another example of a timing device 100. This is generally similar to the devices shown in FIGS. 1, 2 and 3 except in this example the particulates are contained within a glass main body 49 which forms the container for the particulates, but which also has end caps 12 attached onto each end. The glass main body 49 may be formed as a unitary part providing a completely closed container, with the particulates 36 being added to it during manufacture. As in the example of FIGS. 1 to 3, the glass main body 49 has a generally hourglass shape with a recessed portion providing a sounding surface 26 that generates sound when struck by the particulate falling from the upper compartment, and providing a well in which the particulate can accumulate after rebounding from the sounding surface.

In this example, the sounding surface 26 is formed of a locally thinner walled portion of the glass body 49. The end caps protect the ends of the glass body 49 from impacts, as well as providing feet on which the device 100 sits when placed on a surface which provide channels by which the sound generated in the glass cavity escapes. Thus, as in the example of FIGS. 1 to 3, the cavity under the sounding surface 26 and channels formed by the feet can be made to flare outwards to amplify or otherwise channel the sound to reach the listeners. If desired, the end caps may be made to extend further down the sides of the glass body to join up to provide protection and structural support to the glass body.

The end cap 40 also has a protective mesh 50, or other surface with apertures, extending across the cavity 38 so as to protect the delicate sounding surface 26 from any external objects accidentally coming into contact with it and damaging it. The holes in the mesh or other apertures allow the sound to emanate out from the cavity 38. The protective mesh 50 is preferably formed of the same material as the end caps 12 or formed as part of end caps 12, e.g. the end caps are formed by injection moulded plastics material. Although not illustrated, the examples of FIGS. 1 to 3 may also have a protective mesh extending across the opening to the cavity to protect the sounding surface.

In the examples given above, the device has two ends with identically formed end caps which give identical sounds. Other examples are contemplated. For instance, if desired, in some examples, the different sounding surfaces in the device may be arranged to give different sounds. Additionally or alternatively, more than one different compartment containing particulate matter can be provided in the same device. These compartments would each have opposed first and second ends having respective sounding surfaces as in the examples of FIGS. 1 to 4, and each compartment would have orthogonally orientated longitudinal axes, such that orientating the overall device with one of the longitudinal axes upright causes particulate to flow between the compartments in that container, but not the other containers. These may be arranged to measure different time periods and/or give different sounds by varying the sounding surface, i.e. its size, thickness, material or mounting and/or the particulate, i.e. its size or weight. For example, a cube shaped device may have three containers as described herein, each aligned between opposed faces of the cube, such that different flows can be produced by placing the cube on a different face. Other examples can have two containers or more than three containers. Alternatively or additionally, one or more container may have more than two compartments, with pairs of compartments linked by respective passages and having different orientations such that by appropriately orientating the overall device, particulate can be made to flow from one compartment to another.

Embodiments of the present invention have been described with particular reference to the examples illustrated. However, it will be appreciated that variations and modifications may be made to the examples described within the scope of the present invention.

1. A timing device that audibly provides an indication of elapsing time, the device comprising:
a container having walls defining first and second compartments connected by a passage; and
particulates contained in the container;
wherein, with the device positioned to have the compartment containing the particulates uppermost, particulates fall into the lowermost compartment through the passage which regulates their rate of fall such that the particulates accumulate in a base of the lowermost compartment in a set time,
wherein a portion of the wall defining at least one compartment is recessed and has a sounding surface positioned under the passage that is arranged to produce sound when its internal surface is struck by falling particulate providing an externally audible indication of elapsing time,
wherein the recessed portion of wall positions the sounding surface higher than the base of the compartment forming a well in which falling particulate accumulates after striking and rebounding from the sounding surface.

2. A device according to claim 1, wherein the recessed wall portion externally forms a channel and/or an acoustic horn surrounding the external face of the sounding surface, which amplifies and/or guides sounds produced by the sounding surface.

3. A device according to claim 1, wherein the recess is in
the base of the device with the well extending circumferentially around the recessed portion.

4. A device according to claim 3, wherein a plurality of external feet are disposed on the base of the device circumferentially spaced around the recessed portion, such that, with the device placed on a surface, channels are formed between the feet and surface allowing sound to travel from the recessed portion.

5. A device according to claim 4, wherein the plurality of channels between the feet are shaped to amplify the sound created by a particulate colliding with the sounding surface.

6. A device according to claim 5, wherein the shape of the plurality of channels resembling a part of a horn for increasing the amount of air the sound waves acts upon.

7. A device according to claim 1, wherein the sounding surface is less thick than the rest of the recessed walls of the container.

8. A device according to claim 7, wherein the thickness of the sounding surface is proportional to the size and mass of the particulates designed/chosen to collide with it.

9. A device according to claim 1, wherein the sounding surface is formed of a different material than the recessed portion it is affixed to.

10. A device according to claim 9, wherein the sounding surface is made of flexible elastic sheet material fixed under tension to a rigid frame provided by the rest of the recessed wall portion which vibrates when a particulate collides with it to produce a sound.

11. A device according to claim 1, wherein the sounding surface is unitary with the rest of the recessed wall portion.

12. A device according to claim 1, wherein the sounding surface is between 0.05 and 0.75 millimetres thick and/or the sounding surface is between 0.5 cm² and 10 cm² in area.

13. A device according to claim 1, wherein a portion or portions of the walls of the device are transparent providing a visual indication of the extent to which the particulate has accumulated in the lower compartment and so of elapsing time.

14. A device according to claim 13, wherein there are identification markers on the interior walls of recessed portion that indicate how much time has passed as particulates build up and cover the identification markers.

15. A device according to claim 1, wherein the device is constructed from at least one unitary moulded plastics part providing the recessed portion of wall and sounding surface for a respective one or both base ends of the device, wherein the sounding surface has a thinner wall thickness than the surrounding recessed wall portion.

16. A device according to claim 15, wherein the or both unitary part is joined to at least one other part defining the circumferentially outer walls of the compartments and the passage therebetween.

17. A device according to claim 1, wherein the compartment is unitary and preferably made from glass.

18. A device according to claim 1, comprising end caps fixed to one or both ends of the compartment providing a protective shield over the opening of the recessed portion having one or more apertures therein to protect the sounding surface whilst allowing sound out of the recessed portion.

19. A device according to claim 1, wherein there are sounding surfaces in different compartments arranged to produce different sounds.

20. A device according to claim 1, comprising plural containers comprising interconnected compartments each with a sounding surface, wherein the containers are axially orthogonal such that depending on the orientation of the device, particulate is made to fall in one of the containers, wherein each container has a sounding surface that produces a different sound to another container and/or has a different set time.
